(19) United States
(12) Patent Application Publication
(10) Pub. No.: US 2023/0266257 A1
(43) Pub. Date: Aug. 24, 2023

(54) A Detection System and Method for Investigating a Content of an Item

(71) Applicant: Dynaxion B.V., Eindhoven (NL)

(72) Inventors: Emma Wooldridge, Eindhoven (NL); Cornelis Pauwel Datema, Eindhoven (NL); Maximilian Messmer, Eindhoven (NL); Enrico Junior Schioppa, Eindhoven (NL)

(21) Appl. No.: 18/020,673

(22) PCT Filed: Aug. 11, 2021
(86) PCT No.: PCT/IB2021/057408

§ 371 Date: Feb. 10, 2023

(30) Foreign Application Priority Data
Aug. 11, 2020 (NL) 2026256

(51) Int. Cl. G01N 23/2206; G01N 23/222; G01N 23/09

(52) U.S. Cl. CPC G01N 23/2206; G01N 23/222; G01N 23/09; G01N 2223/3306; G01N 2223/643; G01N 2223/316; G01N 2223/204

(57) ABSTRACT

A detection system and method for investigating a content of an item to be inspected, comprising an inspection space for receiving said item and a neutron generator for generating a directional beam of energetic neutrons, directed towards said inspection space. A detector is responsive to interaction products coming from said inspection space and impinging substantially along a detection axis upon interaction of said energetic particles with nuclei of material of said item. Said neutron generator is configured to expose said inspection space to a uni-directional beam of energetic neutrons along an interrogation axis through said inspection space. Said directional beam has a smaller cross section than a corresponding cross section of said inspection space and smaller than a corresponding cross section of said item to be inspected. Said detector detects said interaction products along a detection axis upon interaction of said uni-directional beam of energetic neutrons with said item to be inspected.

The present invention relates to a detection system for investigating a content of an item, the detection system comprising: a particle source comprising a neutron beam generator, configured and arranged for generating a directed beam of neutrons along an interrogation axis toward the item, and detection means comprising at least two gamma ray detectors, configured and arranged to detect gamma ray products of neutron interactions with the item along individual detection axes.

The present invention further relates to a method of non-invasive investigating a content of an item, wherein said item is exposed to a beam of neutrons that interact with material of said item to generate interaction products, wherein said interaction products are detected and analysed by means of processing means.

Particularly, the invention relates to the detection of illicit materials in parcels, mail items, packages and suitcases or the like. Currently billions of articles are transported around the world for the consumer and industrial purposes and this number is growing every year. Any item that is transported by air must be screened for dangerous items. Custom authorities of all nations also wish to inhibit the flow of contraband materials into and out of their countries for the prevention of crime. Current detection methods include visual clues, x-ray inspection, ion spectroscopy and canine detection.

Most common is the use of x-ray detection. This can be in the form of a single energy system, a dual energy system or a CT system. Although dual energy and CT systems provide an enhanced level of contrast and depth perception, these systems are still largely anomaly detectors relying on well-trained personnel as part of the detection method. In practice these X-ray systems appear to produce a high number of false positives. In that case, further investigation of the parcel is needed to confirm its contents. This takes time to resolve the contents and may also require the parcel to be opened and the content to be exposed. For perishable goods this adds a significant delay that may deteriorate their quality, while items that indeed impose a threat may expose personnel to exactly that risk.

There is a demand for a, particularly non-invasive, method of investigating parcels that provides more information about the actual composition of the contents. Such a system and method are for instance known from International patent application WO91/14938. According to this prior art method a pulsed beam of energetic neutrons is used to interrogate a parcel. The particular contents of the parcel that is being irradiated by the beam of neutrons will give rise to several distinct interactions between the neutrons and the substances within the parcel. These interactions can be detected, measured and analysed to provide information on the chemical contents of the parcel. Modern, high impact plastic explosives tend to be nitrogen, hydrogen, carbon and oxygen based. In order to detect such explosives, that might be hidden in airline baggage, this known system is tuned to detect particularly these elements among the contents of the parcel.

To detect hidden explosives, WO91/14938 discloses to employ a pair of pulsed neutron sources that are operated at a pulse rate of 100 Hz for about three seconds. These neutron sources are positioned symmetrically at opposite sides of the item under investigation. Gamma rays at 10.8 MeV are detected to reveal an interaction of nitrogen atoms with slow (thermal) neutrons and to create a nitrogen density image of the package. Additionally, gamma rays at 6 and 7 MeV are detected, as these will be emitted by oxygen atoms following interrogation with fast neutrons, to produce a corresponding oxygen density image. The images are considered together to determine whether the package likely contains explosive material, based on a stored nitrogen-oxygen footprint of known explosives.

WO91/14938 further discloses to include an array of position sensitive neutron detectors on up to all six sides of the detection area for producing a hydrogen density image of the package based on scattering of fast neutrons (2-14 MeV) by hydrogen atoms within the package. To enhance the outcome, conventional X-ray imaging for forming an X-ray image of the package, either two-dimensional or three dimensional, may be added that may be considered together with said nitrogen, oxygen, carbon and hydrogen images. Up to four different detection techniques are thus combined in a single system to deliver a high degree of sensitivity and selectivety to thereby reduce the number of false positives. Neutron absorption may further be measured to provide an indicator of neutron absorbing material within the package.

Although this known system and method provide an advanced non-invasive manner of interrogating an item for its content that is able to discriminate among several distinct chemical elements, the known system is still prone to false positives as it is unable to provide spatial information concerning the traced elements within the item.

The present invention has inter alia for its object to provide a system and method for a non-invasive inspection of an item, circumventing said disadvantage at least to a significant extent.

To that end, according to the invention a detection system of the type as described in the opening paragraph is characterized in that said gamma ray detectors are configured and arranged to be focused to detect gamma ray products uniquely from individual voxels within the item, and in that an overlap between two individual voxels is less than 20 percent, particularly less than 10 percent and more particularly less than 5 percent, of a volume of a smallest one of said voxels. Particularly, this concerns both lateral overlap and vertical overlap between touching voxels and ideally such overlap is kept to a minimum or avoided at all.

A specific embodiment of the detection system according to the invention, further comprising an inspection space for accommodating said item, is characterized in that said neutron beam generator in configured to direct said directed beam of neutrons substantially along said interrogation axis crossing said inspection space, said directed beam of neutrons having a cross section that defines a corresponding cross section of said voxels which is smaller, particularly at least said several times smaller, than a corresponding cross section of said inspection space, and in that said gamma ray detectors are responsive to gamma ray products along said individual detection axes crossing said interrogation axis in consecutive voxels along said interrogation axis to detect gamma ray products from said consecutive voxels.

A method of the type described in the opening paragraph, according to the invention is characterized in that said item is exposed to an at least substantially uni-directional beam of energetic neutrons along an interrogation axis through said item, particularly a fan shaped beam, wherein said at least substantially uni-directional beam is provided with a cross section that is smaller, particularly at least said several times smaller, in at least one direction than a corresponding cross section of said item to be inspected to define a cross section of a voxel of a number of adjacent voxels within said item, in that said interaction products are detected by means of at least one detector that is focused to a particular voxel to detect said interaction products along at least one detection axis upon interaction of said at least substantially uni-directional beam of energetic neutrons with local material within said voxel of said item to be inspected, and in that said item is scanned in consecutive stages to cover said adjacent voxels in three cardinal directions along said item.

Within the context of this application, a beam is supposed to be substantially directional if a cross section of the beam underwent only limited widening or divergence between the neutron beam generator and the inspection space such that the cross section is still narrow as compared to the inspection space, more particularly the item, to be inspected. To that end, a specific embodiment of the detection system according to the invention is characterized in that said neutron generator comprising a collimator for creating a fan beam of neutrons around the interrogation axis, wherein at a first distance from the neutron beam generator a first dimension of the fan beam in a first direction perpendicular to the interrogation axis is at least three times larger than a second dimension of the fan beam in a second direction perpendicular to the interrogation axis, the first direction being substantially perpendicular to the second direction.

The invention is thereby based on the recognition that not only the presence of certain chemical elements within a parcel or other item will reveal the actual presence of a suspicious substance but that particularly a co-presence of certain chemical elements at substantially a same location provides an indication that a contraband liquid or substance might be hidden inside. To that end the invention employs one or more relatively narrow, as compared to the inspection space, substantially uni-directed beam of neutrons to scan and inspect a parcel in several distinct partial volumes, hereinafter referred to as voxels, each lying at a crossing within the parcel of the interrogation axis with a particular detection axis to reveal more detailed information about specifically that voxel. By scanning a parcel over several voxels in one or more directions, particularly in all directions, a significantly more reliable impression is obtained of the actual contents and presence of possibly harmful substances. It turns out that this provides already an adequate spatial detection resolution if the overlap between adjacent voxels is kept less than 20 percent of a volume of the smallest voxel of the adjacent voxels. Particularly such avoidance of substantial overlap concerns both lateral overlap of adjacent voxels in a same plane as well as vertical overlap between superimposed voxels. This spatial detection information may reduce the number of false positives considerably.

Please note that within the context of the present application the expression “parcel” should be interpreted in the broadest sense and not only includes standard packages, but also pieces of luggage, mail and any other items, articles and goods, whether or not wrapped in packaging material.

When neutrons interact with materials the event can be classed as either scattering or absorption. Scattering is further broken down into elastic and inelastic scattering and absorption can be broken down into electromagnetic (production of a gamma ray), charged (production of a charged particle), neutral (production of one or more neutrons), and fission (an atom splits into two or more smaller, lighter nuclei). The gamma ray detectors detect gamma ray product along one or more detection axes crossing said interrogation axis to detect gamma ray products product emitted from said item along such detection axis upon interaction of said item with said at least substantially uni-directional beams of neutrons. The gamma ray detectors are positioned and focused such that they will sense gamma ray radiation that is being emitted from a particular voxel at an intersection of said detection axes with the interrogation axis of the beam of neutrons. Said gamma ray products will be radiated substantially omni-directionally, particularly inter alia in a plane traversing the interrogation axis. By having one or more gamma ray detectors along different detection axes within that plane, a number of directions may be covered over a certain angle to capture substantial gamma ray products that will reveal sufficient information on a particular voxel.

In order to provide depth information about the parcel in several voxels along the interrogation axis, a preferred embodiment of the system according to the invention is characterized in that said one or more gamma ray detectors cover a number of detection axes that are distributed along said interrogation axis. These one or more detectors are, hence, arranged behind one another in a direction of the interrogation axis and may be contained within a shield (collimator) so as to limit the cross talk between them and to limit the detection of any background radiation.

Said one or more detector may provide spatial information concerning the item under investigation. To that end a specific embodiment of the detection system according to the invention is characterized in that said gamma ray detectors comprise adjacent gamma ray detectors in an array of gamma ray detectors that are distributed over said individual detection axes. These detectors will provide their information concurrently. Alternatively or additionally, a further particular embodiment of the system according to the invention is characterized in that said gamma ray detectors comprise a gamma ray detector that is displaceable over individual detection axes. In this case one or more single detectors are carried over several detection axis to provide information on respective voxels, requiring fewer detectors but providing their information consecutively over time.

Apart from fast neutrons that form the beam, the neutron beam generator happens to emit, substantially omni-directionally, als gamma radiation that will (partly) reach the inspection space and is likely to pass partly through the item under investigation. This radiation may be used to provide a transmissive image of the item. A special embodiment of the system according to the invention, therefor, is characterized in that the detection means comprise one or more gamma ray detectors that are arranged opposite said neutron beam generator to detect gamma radiation that passed through said item, and in that a central axis of each of the voxels associated with said gamma ray detectors lie in a single plane. Particularly a combined neutron and gamma ray imaging device may be used where both interaction types can be separated, for instance through light track identification, pulse shape discrimination or pulse intensity.

A further preferred embodiment of the system according to the invention is characterized in that said detection means comprise at least one neutron detector is configured to detect neutrons that have passed through said item. This neutron detector provides a visual representation of the location of items within the inspection space, similar as to x-ray images. Imaging with neutrons have some distinct advantages compared to x-ray images as neutrons have much better penetration capabilities through dense materials. Especially, fast neutron imaging has great potential. The neutron detector can be used for multi-energy imaging, when the neutron source is tuned to different energies. This provides the option to use neutron resonance imaging and to determine the fractions of C, N, O, H that indicate the presence and location of explosives and/or drugs in the investigated object.

In practice several neutron detectors may be used next to one another to provide a spatial image or a single detector may be used to scan an area. In a preferred embodiment, however, the system according to the invention is characterized in that said neutron detector is a position sensitive neutron detector. Such spatially sensitive neutron detector may provide an instant image of at least part of a cross section of the inspection space and the item under investigation.

In order to be able to measure neutrons that are scattered by the material of an item under investigation, a further embodiment of the system according to the invention is characterized in that said detection means comprise at least one neutron detector aside of said inspection space that is capable and configured to detect neutrons that are scattered by said item to be inspected. Neutrons that have lost part of their energy through scattering inside a parcel may be detected by one or more neutron detectors that are positioned somewhere around the inspection space. In addition to transmission imaging of fast neutrons, information about the content of the item can also be determined by measuring or imaging these neutrons with lower or even thermal energies. A particular location for these detectors could be near the outlet of the neutron source. The detector, in that case, measures neutrons that are scattered back in the negative direction, but these one or more detector could in principle be placed anywhere below, above, aside or behind the inspection space.

Depending on the particular chemical composition within a voxel, a specific radiation and scattering pattern is to be expected as detected by the detectors. In a further particular embodiment the detection system according to the invention is characterized in that said gamma ray detectors generate electronic signals in response to an exposure to said gamma ray products, in that said gamma ray detectors are coupled to a data processor receiving said electronic signals from at least said gamma ray detectors, and in that said data processor is configured to generate a signature out of said electronic signals and to comparing said signature with at least one of stored reference signatures. Such comparison of a specific radiation and scattering pattern against stored reference signatures, saves considerably on computational power and renders the system extremely fast. The reference signatures may be acquired upon analysing known substances with the same or similar detection system and storing these signatures as reference signatures for later operation.

The detector(s) will measure the different outputs from the interactions of the neutrons with the elements in the parcel. For optimal performance the neutron generator preferably is pulsed. To that end, a specific embodiment of the detection system according to the invention is characterized in that said neutron generator is configured to generate a pulsed beam of neutrons. Particularly, the neutron source comprises a pulsed neutron generator that produces a series of relatively short, relatively intense bunches of neutrons at a relatively high repetition rate. In a preferred embodiment the detection system of the invention is thereby characterized in that said gamma ray detectors are synchronized with said neutron beam generator to detect gamma ray products during a pulse of said pulsed beam of neutrons and/or in between consecutive pulses of said pulsed beam of neutrons. Using such accurate time information from the pulsed neutron source provides the option to minimize background and optimally detect signals from individual interaction mechanisms.

The inelastic gamma rays and capture gamma rays are produced at different time scales. By using fast electronics it is possible to split these two items apart from each other with high clarity. In this respect, a specific embodiment of the detection system according to the invention is characterized in that said detection means comprise detection means that are synchronized to detect interaction products during each bunch of neutrons. Gating of the detectors may be synchronized to the neutron generator's pulses. Inelastic scattering gamma-ray detection and fast neutron imaging may be performed during the neutron pulse. Any capture gamma-rays and lower energy neutron may be detected during an off-pulse period in between consecutive neutron bunches. To that end, a specific embodiment of the detection system according to the invention is characterized in that said detection means comprise detection means that are synchronized to detect interaction products in between consecutive bunches of neutrons.

In a further preferred embodiment, the detection system according to the invention is characterized in that said beam of neutrons comprises at least primarily neutrons having an energy greater than 6 MeV. These highly energetic neutrons appear to provide sufficient gamma ray product to render the detection reliable and fast.

To maintains sufficient neutron flux and directional information, the beam of neutrons is preferably highly directional. In that respect, a further embodiment of the detection system according to the invention is characterized in that said neutron generator comprising a collimator for creating a fan beam of neutrons around an optical axis, wherein at a first distance from the neutron beam generator a first dimension of the fan beam in a first direction perpendicular to the optical axis is at least three times larger than a second dimension of the fan beam in a second direction perpendicular to the optical axis, the first direction being substantially perpendicular to the second direction. To collect information from any neutrons in such a fan shaped beam that pass through the item under investigation, a preferred embodiment of the detection system according to the invention is characterized in that a neutron detector is positioned opposite the neutron beam generator having dimensions substantially matching the dimensions of the fan beam at the position of the neutron detector.

A significant proportion of the beam of neutrons will not interact with the parcel. Therefore, a single, common neutron source may be used to scan several parcels simultaneously or within quick succession. Based on this recognition, a further embodiment of the detection system according to the invention is characterized in that at least one further inspection space is provided along said interrogation axis of said directional beam of neutrons, in line with said first inspection space, said at least one further inspection space accommodating g a further item to be inspected concurrently with said first item to be inspected. Any items in said one or more further inspection spaces are being scanned and may be analysed concurrently with a parcel within said first inspection space with the aid of neutrons that passed through the preceding inspection space(s). To that end every single inspection space may be provided individually with a set of appropriate detectors and associated electronics.

To decrease cross talk between consecutive inspection spaces, appropriate neutron shields may be placed between inspection spaces. To that end, a specific embodiment of the detection system according to the invention is characterized in that adjacent inspection spaces are shielded from one another by means of a neutron shield that has a window at said interrogation axis. Said window may be a small aperture for the beam to pass through. In order to avoid too much divergence of the beam along its trajectory through consecutive inspection spaces, a further embodiment of the detection system according to the invention is characterized in that collimator means are provided along said window that are configured to collimate said at least substantially uni-directional beam of energetic neutrons along said interrogation axis. The aperture(s), slit(s) or window(s) also act as a collimator in such a case to keep the bundle sufficiently narrow, particularly several times smaller than a corresponding scale of the item to be scanned.

To enhance the scanning efficiency and throughput of the system, a preferred embodiment of the detection system according to the invention is characterized in that a pre-inspection space is provided receiving said item to be inspected prior to said inspection space, wherein said item is subjected to a flood inspection at said pre-inspection space, and more particularly in that said flood inspection comprises at least one of a visual inspection, an X-ray inspection and a beam of neutrons interrogation of said item. An addition could be to add a conventional x-ray machine to the setup to do a pre-scan of parcels and preselect items of interest. Such X-ray inspection may require additional hardware on the premises, although in many cases existing hardware and software may be re-used that was applied so far for conventional X-ray scanning of items.

A pre-scan may also be performed by means of a flood exposure to neutrons from the same neutron source as is being used for a more detailed scanning of items. To that end, a special embodiment of the detection system according to the invention is characterized in that said pre-inspection space is in line with said inspection space and said item is exposed at said pre-inspection space to said at least one beam of energetic neutrons at a diverged cross section that exposes a corresponding cross section of said pre-inspection space, particularly a corresponding cross section of said item to be inspected. This way all items may be flood illuminated initially to look at the resulting gamma-ray spectrum, while another item is being scanned for a more detailed inspection.

In the case that such a pre-inspection provides no indications for illicit goods, the item may move directly to the exit. Only if the pre-scan highlights materials of interest the parcel is scanned more closely with a narrow beam. A further embodiment of the detection system according to the invention, to that end, is characterized by transportation means, particularly comprising a conveyor belt, that carry said item to be inspected through said pre-inspection space and to either said inspection space or an output depending on an inspection outcome of said flood inspection of said item at said pre-inspection space.

A major advantage of this approach is that depending on the number of parcels that need to go through the detailed screening, the system can operate at much higher speed than when every parcel needs to be fully scanned. A buffer area to hold parcels waiting for the more detailed scan may additionally be provided to gain flexibility.

Preferably an item is scanned within the inspection space along all three Cartesian axes. In order to avoid a complicated suspension of the neutron source and/or detectors that are being used that would render them displaceable along one or more of those Cartesian axes, preferably the detection system is configured to move the item through the neutron beam for investigating the whole item. To that end a very convenient and practical embodiment of the detection system according to the invention is characterized in that said inspection space comprises a displaceable support platform for receiving said item to be inspected, wherein said support platform is coupled to drive means that are configured to force said platform into a translation and/or a rotation during an investigation that is controlled by controller means.

In a preferred embodiment the detection system according to the invention is thereby characterized in that said support platform is suspended for axial displacement along a traverse axis that is substantially perpendicular to said interrogation axis and/or wherein said support platform is suspended for a rotation around said traverse axis, wherein said drive means are configured to force said platform into an axial displacement along said traverse axis and/or said drive means that are configured to force said platform into a rotation around said traverse axis. A rotation of the item will expose voxels to the beam of neutrons in a common single plane through the item, while an up and down movement may add the voxels in subjacent and superimposed levels.

In order to focus the gamma ray detectors uniquely to a particular voxel within the item under investigation, the detectors may be provided with a limited detection aperture. To that end a specific embodiment of the detection system according to the invention is characterized in that said gamma ray detectors are accommodated in a housing in between collimator walls that collimate said gamma ray products created from the interaction of said item with said beam of neutrons, thereby focusing the subject detector on a particular voxel. In that respect, a special preferred embodiment of the detection system according to the invention is characterized in that that said gamma ray detectors and said collimator walls are axially displaceable with respect to one another to thereby shifting said detector in between said walls. Such axial displacement of a detector within its collimating enclosure dynamically changes its lines of sight and, hence, the detection window of the detector concerned. Particularly the gamma detectors may be moved along the detector housing to ensure that the voxel that is being investigated in the parcel is substantially the same size as all others as the item is scanned.

To be able to derive a three-dimensional image of the content of an item under investigation, the neutron beam generator, the detectors and/or the item may be moved relative to one another to cover all three cardinal axes. Alternatively, a particular embodiment of the detection system according to the invention is characterized in that said interrogation axis by said beam of neutrons is inclined with respect to a face of said item under investigation. Being inclined, the beam of neutrons will cross the item diagonally thereby covering voxels is different levels of the item under investigation. In a further embodiment the detection system is further characterized in that said gamma ray detectors and said item under investigation are movable with respect to one another in a direction parallel to said item, wherein more particularly said gamma detectors move synchronously with the item under investigation. This will ensure that the entire item will be scanned without necessary displacement of the item itself.

The detection system and method according to the invention may be configured to allow a local investigation on a voxel-by-voxel basis using a directional beam of neutrons. To that end an specific embodiment is characterized in that said beam of neutrons emanate from said neutron beam generator through an aperture that is reduced to produce a substantially shaped beam of neutrons. Alternatively or additionally a total scan on the item may be performed with a further embodiment of the system and method that are characterized in that said beam of neutrons emanate from said neutron beam generator through an aperture that is increased to produce a flood illumination by said beam of neutrons.

The invention also relates to a method of non-invasive inspecting the content of an item. In a particular embodiment one or more of: elastically scattered neutrons, inelastically scattered neutrons, transmitted neutrons, emitted neutrons and transmitted photons, particularly gamma ray photons, are being detected and analysed as interaction products in such method.

The beam of neutrons may be is pulsed and delivered as a series of consecutive bunches of energetic neutrons during a pulse time at a repetition rate. The interaction products may be detected and analysed during each bunch and/or the interaction products may be detected and analysed in between bunches.

During an inspection, the item may rotated around an axis of rotation to expose said item from several angles and/or the item may be translated parallel to, particularly along, said axis of rotation during said inspection to expose said item at several heights. Also several items may be inspected concurrently using a single at least substantially uni-directional beam of energetic neutrons by placing them behind one another along said interrogation axis.

Particularly satisfactory results are achieved with a preferred embodiment of the system and method according to the invention that are characterized in said neutron beam generator comprises a Radio Frequency Quadrupole (RFQ) having an ion source and an target, wherein said ion source generates deuterium ions and said target holds deuterium within a metal.

Hereinafter the invention will be described in further detail with reference to a number of specific embodiments and a drawing, that will reveal further details, embodiments and variations of the detection system and method according to the invention. In the drawing:

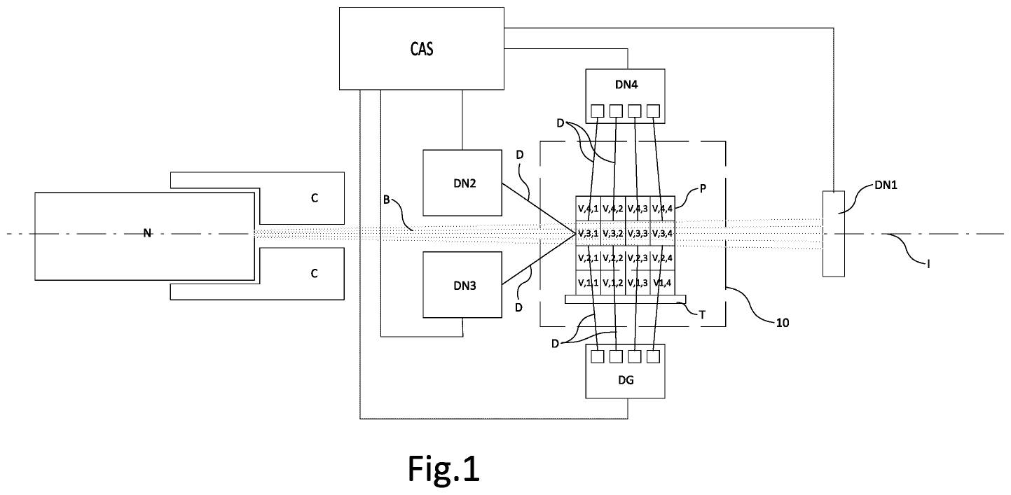

FIG. 1 shows a schematic setup of a first embodiment of the detection system according to the invention;

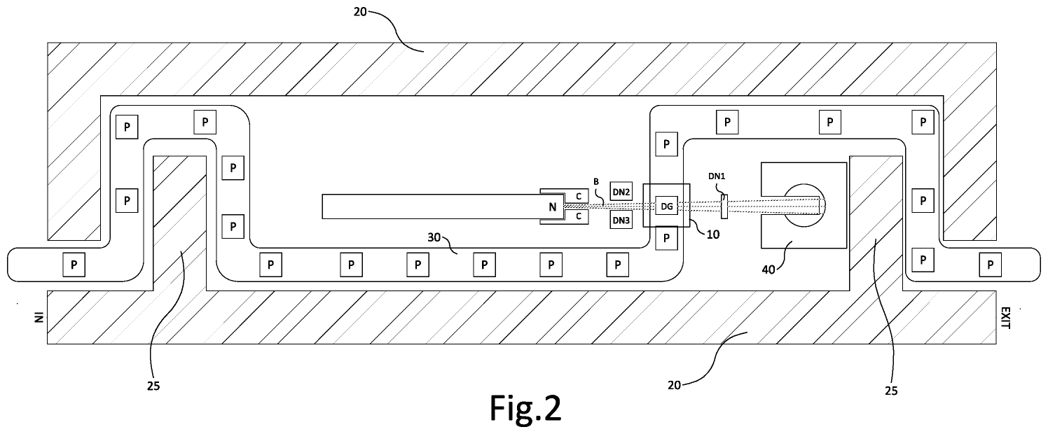

FIG. 2 shows a schematic setup of a further embodiment of the detection system according to the invention;

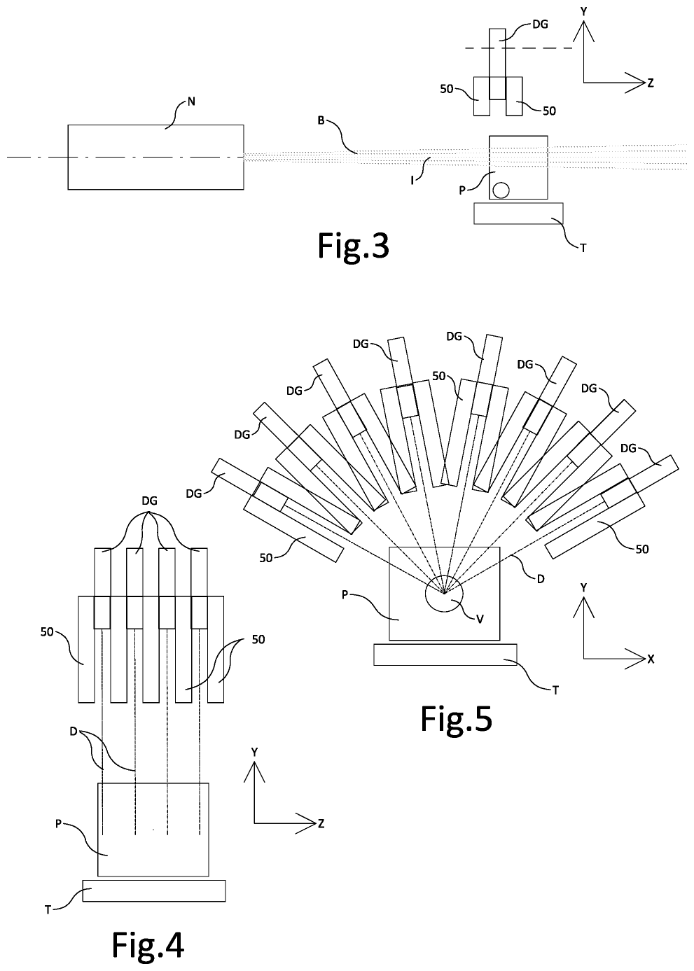

FIG. 3 shows a schematic setup of a further embodiment of the detection system according to the invention;

FIG. 4 shows a schematic setup of an array of gamma ray products detectors along an interrogation axis of a detection system according to the invention;

FIG. 5 shows a schematic setup of an array of gamma ray products detectors traverse to an interrogation axis of a detection system according to the invention;

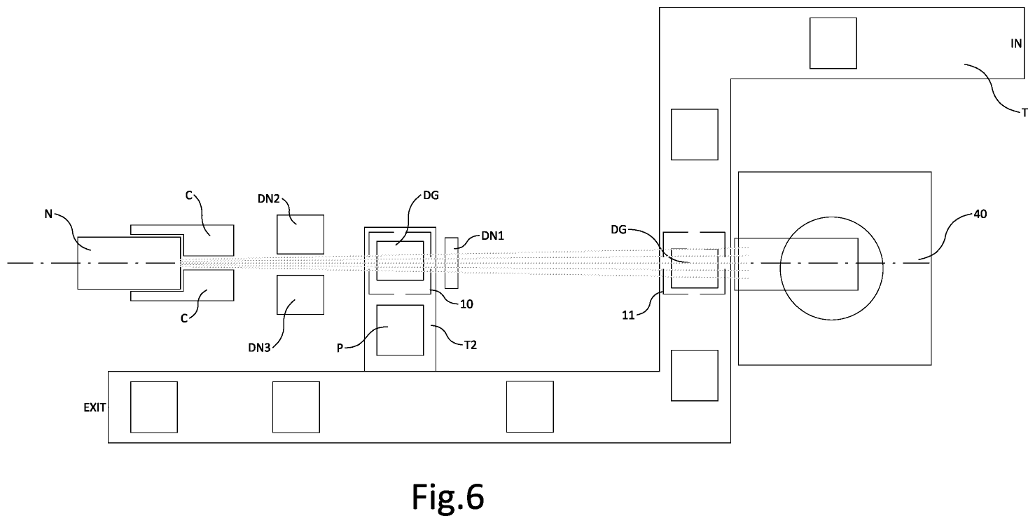

FIG. 6 shows a schematic setup of a further embodiment of the detection system according to the invention;

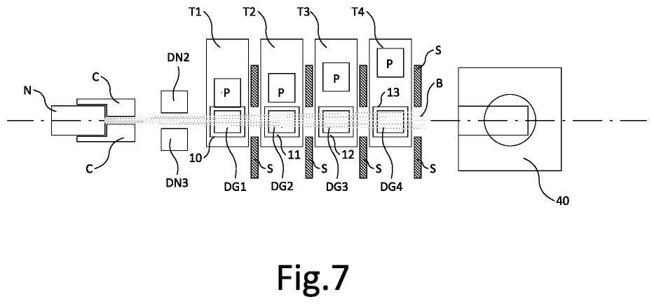

FIG. 7 shows a schematic setup of a further embodiment of the detection system according to the invention;

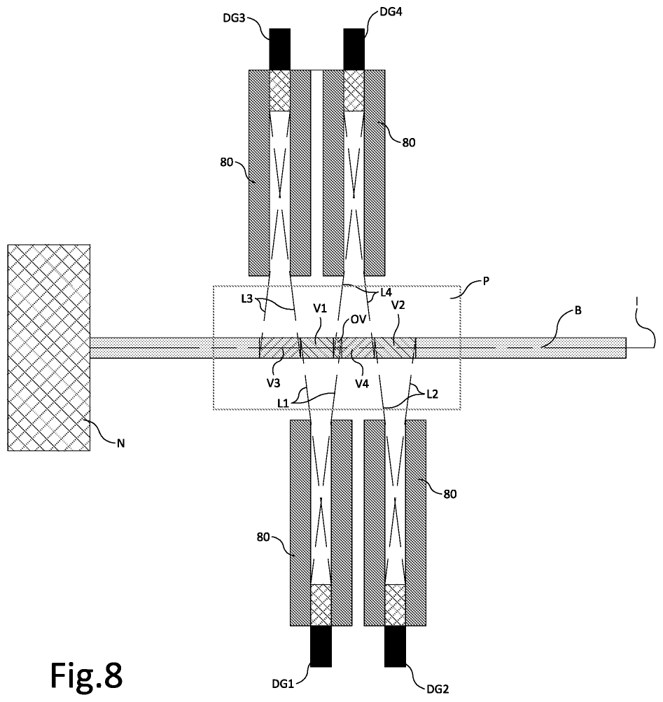

FIG. 8 shows a schematic setup of a further embodiment of the detection system according to the invention;

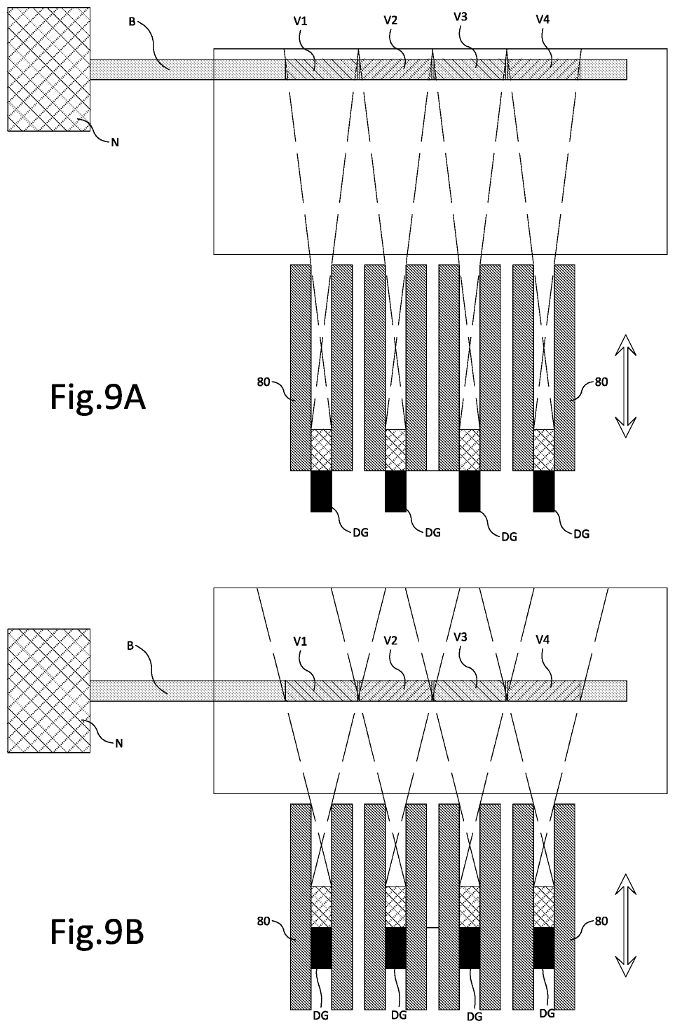

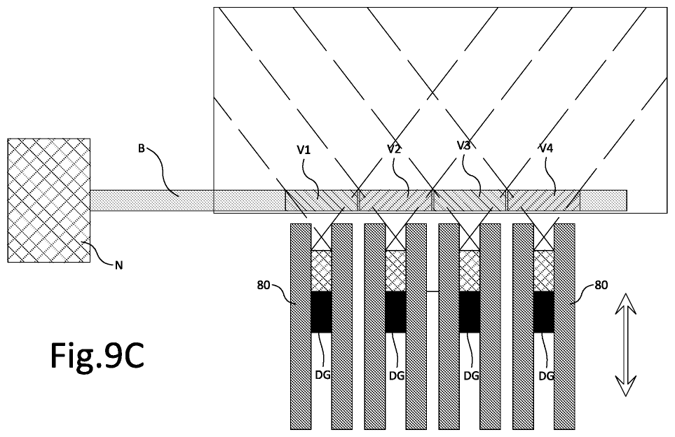

FIG. 9A-C show a schematic setup of a further embodiment of the detection system according to the invention in different stages of operation; and

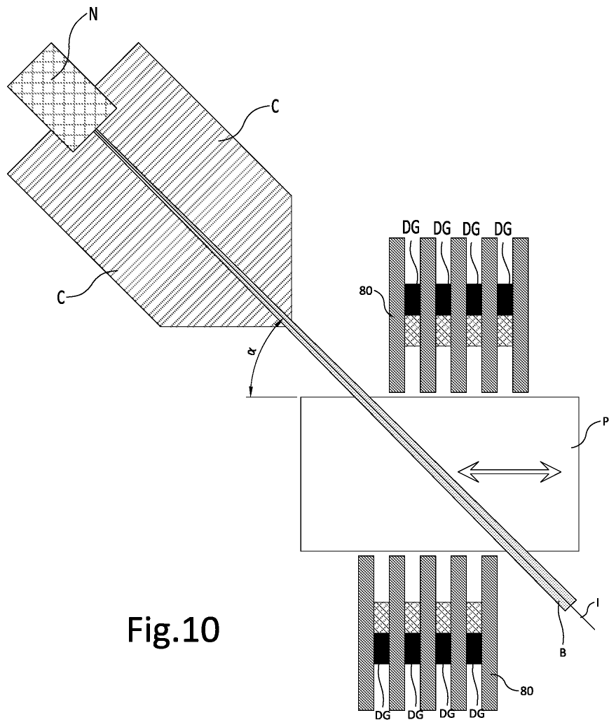

FIG. 10 shows a schematic setup of a further embodiment of the detection system according to the invention.

It should be noted that the figures are drawn purely schematically and not to scale. Particularly, certain dimensions may be exaggerated to a greater or lesser extent with an aid to better understanding the invention. Similar parts of the system are generally denoted by a same reference numeral throughout the drawing.

FIG. 1 depicts in a side view the basic setup of an embodiment of a detection system according to the invention, hereinafter also briefly referred to as scanner. A parcel P is brought into an inspection space 10 of the system by means of a suitable transportation system T, where it is aligned along an axis of a narrow beam B that is generated by a neutron source N. This beam axis I provides an interrogation axis I along which the parcel P is being inspected. The inspection space 10 is surrounded by a number of detectors in specific locations to detect particular interaction products, along their respective detections axes, that are a result of interaction by the emitted neutrons with the chemical contents of the parcel that is within the beam, i.e. along the interrogation axis.

The generator N sends one or more thin neutron bunches to the parcel P. These are synced with the gating properties of the detectors DG,DN1 . . . 4. The parcel P is moved through the beam B. The detectors DG,DN1 . . . 4 take measurements along their respective detection axes D of gamma rays generated from inelastic collisions and neutron capture (DG), of neutrons that pass through the parcel (DN1) and of neutrons (back) scattered out of the parcel (DN2,DN3,DN4). The detectors DG,DN1 . . . 4 output their detection signals to a sophisticated Content Analysis System CAS that uses the information from all or some of these detectors to provide a detection response. The system CAS uses deep learning and other classification algorithms, or a combination of these, to determine the chemical composition of a volume area V,1,1 . . . V,4,4 of the parcel that is being scanned, based on reference signatures of known substances that could be suspicious. The parcel P exits at the other side of the scanner and is either cleared for onward travel or diverted to a quarantine area. Note that the expression “parcel” is used through this application to denote any kind of item to be inspected and can equally be used for luggage or standard post.

When neutrons interact with materials the event can be classed as either scattering or absorption. Scattering is further broken down into elastic and inelastic and absorption can be broken down into electromagnetic (production of a gamma ray), charged (production of a charged particle), neutral (production of one or more neutrons), and fission (atom splits into two or more smaller, lighter nuclei). The depicted system of FIG. 1 comprises a detector DG for the direct measurement of gamma-rays, produced by inelastic scattering or neutron absorption, and one or more detectors DN1 . . . DN4 for the detection of (back) scattered (DN2 . . . DN4) or transmitted (DN1) neutrons to provide information on the content of the investigated object.

The information of the interaction mechanisms described above provide specific information about the atomic composition of the substance under investigation. Although most elements can be identified in this way, the elements under consideration include, but are not limited to, C, H, O, N, S, Na, Cl, B, Br, Li, F. Furthermore, the imaging of the transmitted neutrons provides additional information about the location of the substances present in the parcel.

FIG. 1 shows the main configuration of the system. The neutron generator N emits a narrow beam of neutrons along an interrogation axis I towards a parcel P that is in the inspection space. Gamma-rays that are being produced within the parcel are detected by one or more gamma-ray detectors DG. Fast neutrons that pass through the parcel are detected by a fast neutron imaging device DN1. Neutrons that have lost part of their energy through scattering inside the parcel are detected by one or more neutron detectors DN2 . . . DN4.

The beam that is produced by the neutron source is several times narrower than a corresponding cross-section of the parcel P such that only a portion, or certain portions, of the parcel is being scanned. This will provide localized information of the parcel P relating to a particular, local volume portion, referred to as voxel, of that parcel P. FIG. 1 schematically shows a matrix of sixteen of such volume portions V,1,1 . . . V,4,4 that are in a same plane V of the drawing and that are selectively scanned by the system by moving the parcel P stepwise or continuously through the beam B in all Cartesian directions. Every detector DG,DN1 . . . 4 has its own line of sight, referred to as detection axis D, which is directed towards a particular volume area within the parcel. To be able to discriminate between adjacent voxels the detectors are focused such that an overlap between adjacent voxels is kept below 20% of their volume. In case of different volumes the smallest volume is being taken. Preferably both the lateral and vertical overlap between adjacent voxels is maintained below 10% and more particularly below 5% or avoided anyway.

The system is self-contained within a surrounding shielding 20 that provides an entrance IN and exit OUT for the parcels P, as shown in top view in FIG. 2. The parcel is being carried and transported by a conveyor belt 30. At the entrance IN and exit OUT, the parcel and a conveyor belt 30 pass around a maze-like extension 25 of the shield 20 that prohibits radiation from escaping from the enclosure. Once past the entrance maze, the parcel is conveyed to the scanning and inspection space 10. Any necessary parcel rearrangement may be carried out between the entrance IN and the scanning area 10. This rearrangement may include repositioning of the parcel P on the belt 30 or rotating it. To achieve optimum positioning of the parcel the system may use information from external sources. This could include a visual image of the parcel or other intelligence.

Behind the inspection space 10 is a beam stop 40. One of the advantages of using a directed beam of neutrons is that neutron shielding will be easier. The majority of all neutrons that are generated will move in the forward direction towards the parcels after which the beam stop 40 is placed. This beam stop 40 is responsible for slowing down the neutrons as well as absorbing them and the associated secondary radiation. This means that shielding requirements for the overall system can be less stringent than for typical neutron sources that generate neutrons omni-directionally. The beam stop is for instance made of several layers of neutron modelling and neutron absorbing materials.

As neutrons are scattered and captured they will generate gamma rays. This can occur from any atom in the beam but also from atoms outside the beam that are subsequently hit. Those not from the area of interest may add to the gamma background that is seen by the gamma-ray detector DG and need to be screened out. The conveyor belt 30 is designed to produce a minimal gamma background in the inspection space 10 from its interaction with the beam of neutrons. To reduce the amount of background signal from the conveyor belt, the use of materials with components equal to the ones that are mostly sought after (C, N, O, H) should be avoided. Also, materials that produce secondary radiation with energies close to the ones of the commonly investigated substances should be avoided. This has led to the use of stainless steel and aluminium as preferred materials for the conveyor belt in the scanner area.

The parcel is moved backwards and forward and up and down as required within the inspection space 10 to provide a complete scan over several individual voxels within the parcel P.

Alternatively the parcel is moved up and down while being rotated 360 degrees around a vertical axis to provide a complete image.

Neutrons are generated within the neutron source N by accelerating ions towards a target where, at impact, mainly forward directed neutrons are created to form the beam B. The choice of ion, acceleration energy and target material determine the emitted neutron spatial and energy distribution. The neutron generator is pulsed and produces relatively short, thin, intense bunches of neutrons at a high bunch repetition rate. The accelerator N that is used in this embodiment is based on the use of a Radio Frequency Quadrupole (RFQ), which provides ion bunches in a compact space. To further enhance the quality of the beam of neutrons, a neutron collimator C may be used. This has the additional advantage that shielding of fast neutrons that are emitted within the source N but that are not directed towards the parcel, and hence will not contribute to the parcel scanning process, is done close to the source. This contributes to lower shielding requirements at the peripheral shielding 20 of the system.

One or more gamma-ray detectors DG are placed above the inspection space 10 accommodating the parcel P. The detector DG measures the energy of gamma rays that impinge on the sensitive detector area. To get depth information about the location of certain materials within the parcel P, either a single detector can move along the z-direction or multiple detectors may be placed in a line or in a pattern. This is indicated in FIG. 3. These detectors DG may be contained within a shield (collimator) 50 so as to limit the cross talk between them and to limit the detection of any background radiation. FIG. 4 (side view) and FIG. 5 (front view) show a possible configuration of a group of detectors DG in a shielded enclosure 50 where all detectors are pointing to a voxel V along the interrogation path I of the neutrons through the Z plane.

A position-sensitive neutron detector DN1 may be placed in the beam of neutrons B behind the parcel, see FIG. 1. This provides a visual representation of the location of items within the parcel P, similar as to x-ray images. Imaging with neutrons have some distinct advantages compared to x-ray images as neutrons have much better penetration capabilities through dense materials.

The neutron detector DN1 can be used for multi-energy imaging if the neutron source N facilitates this option. This provides the option to use neutron resonance imaging to determine the fractions of C, N, O, H and indicate the presence and location of explosives and/or drugs in the investigated object P.

In addition to the transmission imaging, information about the content of the parcel P can also be determined by measuring or imaging neutrons with lower (or even thermal) energies. A likely location for these detectors DN2,DN3 is in line with the end of the generator N, see FIG. 1. These detectors DN2,DN3 measure neutrons that are scattered back in the Z direction. One or more of such neutron detectors DN4 could also be placed for example below or behind the parcel P, see FIG. 1. A gating of the detectors is synchronized to the neutron generator's pulses. The inelastic scattering gamma-ray detection DG and fast neutron imaging DN1 is done during the neutron pulse; the capture gamma-rays and lower energy neutron detection DN2,DN3 are performed off-pulse.

Time coded information for some or all of the detectors DG, DN1 . . . DN4 is used to provide an analysis of the parcel contents. The classification of the content is done using one or more algorithms, for example classification algorithms such as boosted trees, or by machine learning algorithms, for example based on deep learning, or a combination of multiple algorithms to obtain a higher certainty.

Initially the algorithm will be trained to look for suspected substances and indicate whether for example a drug or explosive is inside the parcel. This will create reference signatures that may be stored such that later realtime detector information may be compared against these reference signatures. The algorithm will be able to determine with a high certainty which substance and what amount is likely to be present in the investigated object.

In addition to the above analysis, images can also be created from the gamma detector(s) DG and fast neutron detectors DN1 to highlight the area V that is suspected to contain contraband material. This result in detailed location information about the suspected substance required for faster manual inspection.

Furthermore, also information from external sources may be used by the analysis algorithm(s). This could include x-ray or visual images of the parcel or other intelligence, which may include shipping information. In addition, the physical properties of the parcel may be used. These may include size, weight, weight distribution and external packaging. The algorithm may be suited (trained) to filter standard, known packaging materials from the output signals.

By moving the parcel in the X- and Y-direction, either continuously or stepwise, through the narrow beam B consecutive volume areas V,1,1 . . . V4,4 (voxels) may be scanned individually in the above described manner to be searched for illicit materials. Instead of scanning each parcel thoroughly, an alternative approach would be to initially flood illuminate every parcel and to determine the resulting gamma-ray spectrum. In case there are no indications for illicit goods, the parcel can move directly to the exit. Only if the flood illumination highlights materials of interest the parcel is scanned more closely with a narrow beam as described hereinbefore. This principle is depicted in FIG. 6.

Advantageously such flood exposure is given by means of fast neutrons that passed through the inspection space 10. To that end this embodiment provides an further inspection space 11 that is inline with the first inspection space 10 to be exposed to these transmitted neutrons. The second inspection space 11 is also equipped with one or more gamma ray detectors DG and neutron detectors (not shown) to provide information on the general contents of the entire parcel P. A conveyor belt T carries the parcel(s) P first through the second inspection space. If no suspicious contents is detected the parcel may continue directly to the exit. In the other case it will be shifted to a further transportation mechanism T1 that will carry and/or manipulate the parcel in the first inspection space 10 to obtain a detailed scan by the narrow beam B over consecutive partial volume areas (voxels).

The main advantage of this approach is that, depending on the number of parcels that need to go through the detailed screening, the system can operate at much higher speed than when every parcel needs to be fully scanned. A buffer area T2 to hold parcels waiting for the more detailed scan may also be provided. A further addition could be to add a conventional X-ray machine to the setup to do a pre-scan of the parcel and preselect items of interest.

Another way in which the screening speed can be increased is to simultaneously scan multiple parcels with one and the same beam of neutrons B. A significant proportion of the beam of neutrons B will not interact with a parcel P that is placed in the inspection space 10. Instead this portion of the beam will continue its path along the interrogation axis I and may be used to scan one or more parcels P in consecutive inspection spaces 11,12,13 that are aligned along said axis as shown in FIG. 7.

A single neutron generator N may be used in this manner to scan several parcels simultaneously or within quick succession. The parcels P are carried by separate conveyor belts T1,T2,T3,T4 and can be moved through the beam sequentially, all at the same time or with a random pattern. Parcel sizes may vary significantly and likewise also a total scan time to search the entire parcel.

To decrease cross talk in some implementations, a layer of shielding S may be placed between consecutive inspection spaces 10 . . . 14 with consecutive conveyor belts T1 . . . T4. This shielding S comprises a small aperture or slit for the beam B to pass through. This aperture may also act as a collimator.

Each parcel P may be scanned by translating the parcel in two Cartesian directions through the beam B; for instance left-right and up-down. An alternative to such scanning left-right of a parcel would be to rotate the parcel through the beam on a platform that is moved up or down during the rotation. The total parcel may be scanned in this manner in a single continuous movement, thus avoiding many start-stop actions that may be associated with left-right scanning. This provides similar information on the content of the parcel as with a left-right scanning technique.

FIG. 8 shows a further embodiment of the detection system according to the invention. The detection system comprises a neutron generator N delivering a directional beam B of energized neutrons along an interrogation axis I. This beam crosses a parcel P to be investigated. To that end the system comprises an array of adjacent gamma ray detectors DG1-DG4 at opposite sides of the parcel P. The detectors DG1-DG4 are accommodated within individual enclosures in between collimating walls 80. These walls 80 limit the detection aperture, defined by the lines of sight L1-L4 of the individual detectors DG1-DG4. As a result the detectors DG1-DG4 are focused to receive gamma ray products from particular voxels V1-V3 only, that are hence uniquely associated with a specific detector DG1-DG4. As shown in the figure the detectors DG1-DG4 and their lines of sight L1-L4are laid out such that the individual voxels V1 show hardly no overlap OV with one another in order to provide spatial resolution to the information obtained from the output signals of the individual detectors DG1-DG4. In accordance with the present invention said overlap OV is maintained below 20% of the volume of the smallest voxel V1-V4 being inspected concurrently.

FIG. 9A-9C show a further embodiment of a detection system according to the invention. To ensure an overlap of less than 20% between adjacent voxels V-V4 is subjacent layers of the parcel P and to maintain a fixed voxel size (volume), the gamma ray detectors DG are suspended axially displaceable within their respective collimating enclosures 80. The embodiment of FIGS. 9A-9C comprises an array of four adjacent gamma ray detectors DG that may shift in between the collimating walls as indicated by the arrow in the figure.

In a first stage of operation the detectors are situated below in their enclosure to confine their lines of sight L to a relatively small detection aperture. In this stage shown in FIG. 9A, the top level of the parcel P is being scanned over a number of adjacent voxels V1-V4. The array of detectors DG is shown in only one direction along the interrogation axis of the neutron generator N. However, like in the preceding embodiment the array may be extended perpendicular to the plane of the paper to provide a matrix that covers similar voxels in the same XY plane.

To scan voxels in subjacent layers the neutron beam generator N and the parcel are moved with respect to one another in the Z-direction as shown in FIG. 9B. Concurrently the detectors

DG are shifted upwards in their collimating housing to increase their detection aperture in order to maintain a same voxel size in this lower level of the parcel P.

Finally the detectors may be moved entirely upwards as shown in FIG. 9C to scan the lowest voxel layer in the parcel P, again maintaining substantially a same voxel sight and avoiding substantial mutual overlap between adjacent voxels.

FIG. 10 shows a further embodiment of a detection system according to the invention. In thus case the neutron beam B is not directed perpendicularly to a face of the parcel B under investigation, but instead under an inclined angle a. This allows the beam B to travel diagonally through the parcel as it is being investigated, thereby crossing several subjacent layers of voxels with the parcel, The parcel P is movable in the axial direction indicated by the arrow in the figure to cover all voxels in the XY-plane. As shown in the figure the neutron beam generator N is provided with a neutron collimator C with a reduced output aperture to produces a pencil or fan shaped directional beam of neutrons.

The neutron source N may be configured to generate beams of neutrons at multiple energies. These neutrons may be used for fast neutron resonance imaging. By carrying out the imaging at multiple energies different elements may be highlighted in scanned locations. This may be added to the detection algorithm. Neutrons may be generated within a neutron source N by accelerating ions towards a target where, at impact, mainly forward directed neutrons are created to form a beam of neutrons B. The choice of ion, acceleration energy and target material determine the emitted neutrons' spatial and energy distribution.

The neutron source of the preceding embodiments is based on a deuterium-deuterium reaction in a target that holds deuterium in a metal. When the neutrons are produced, some will react with said metal to generate x-rays. By addition of one or more (secondary) detector panels in the line of the beam behind the inspection space, these x-rays may be used for x-ray imaging. The remaining neutrons leave the target. A mainly forward directed beam may be sculptured and collimated to have a relatively narrow footprint to produce a substantially uni-directional, relatively narrow beam to be employed according to the present invention.

The neutron source uses a Radio Frequency Quadrupole (RFQ), which provides ion bunches in a compact space. The RFQ neutron source comprises a ion source of deuterium which is emitted in pulses. If necessary the ions are fed through low energy beam elements so that the bunch can be accepted by an accelerator. The accelerator accelerates the ions in a vacuum and, because it is an RFQ, makes the bunches smaller. At the end of the accelerator, or at a short distance from it but still under vacuum, the beam collides with a target. This causes a fusion reaction within the target that produces and releases neutrons. By increasing the ion beam energy, these neutrons will be produced at a higher yield and/or at a higher energy. An alternative to is to use different target materials. By rotating the different target materials, one can quickly move from one energy to the next. Another alternative would be to dynamically moderate the beam of neutrons. By inducing certain amounts of material in the beam, the neutron energy of the emitted neutrons will decrease to lower values.

Although the invention has been described hereinbefore with reference to merely a few particular embodiments, it will be appreciated that the invention is by no means limited to these embodiment. On the contrary, to a person of ordinary skill many more embodiments and variations of the present invention are feasible within the framework of the invention without requiring any inventive skill.

1. A detection system for investigating a content of an item, the detection system comprising: a particle source comprising a neutron beam generator, configured and arranged for generating a directed beam of neutrons along an interrogation axis toward the item, and detection means comprising at least two gamma ray detectors, configured and arranged to detect gamma ray products of neutron interactions with the item along individual detection axes, wherein said gamma ray detectors are configured and arranged to detect gamma ray products uniquely from individual voxels within the item, and wherein an overlap between two individual voxels is less than 20 percent, particularly less than 10 percent and more particularly less than 5 percent, of a volume of a smallest one of said voxels.

2. A detection system according to claim 1, further comprising an inspection space for accommodating said item, wherein said neutron beam generator is configured to direct said directed beam of neutrons substantially along said interrogation axis crossing said inspection space, said directed beam of neutrons having a cross section that defines a corresponding cross section of said voxels which is smaller, particularly at least said several times smaller, than a corresponding cross section of said inspection space, and wherein said gamma ray detectors are responsive to gamma ray products along said individual detection axes crossing said interrogation axis in consecutive voxels along said interrogation axis to detect gamma ray products from said consecutive voxels.

3. Detection system according to claim 1, wherein said gamma ray detectors comprise a gamma ray detector that is displaceable over individual detection axes.

4. Detection system according to claim 1, wherein said gamma ray detectors comprise adjacent gamma ray detectors in an array of gamma ray detectors that are distributed over said individual detection axes.

5. Detection system according to claim 1, wherein said gamma ray detectors generate electronic signals in response to an exposure to said gamma ray products, wherein said gamma ray detectors are coupled to a data processor receiving said electronic signals from at least said gamma ray detectors, and wherein said data processor is configured to generate a signature out of said electronic signals and to comparing said signature with at least one of stored reference signatures.

6. Detection system according to claim 1, wherein said detection means comprise one or more gamma ray detectors that are arranged opposite said neutron beam generator to detect gamma ray products that passed through said item, and wherein a central axis of each of the voxels associated with said gamma ray detectors lie in a single plane.

7. Detection system according to claim 1, wherein said detection means comprise at least one neutron detector is configured to detect neutrons that have passed through said item.

8. Detection system according to claim 7, wherein said neutron detector is a position sensitive neutron detector.

9. Detection system according to claim 1, wherein said neutron generator is configured to generate a pulsed beam of neutrons.

10. Detection system according to claim 9, wherein said gamma ray detectors are synchronized with said neutron beam generator to detect gamma ray products during a pulse of said pulsed beam of neutrons or in between consecutive pulses of said pulsed beam of neutrons.

11. Detection system according to claim 1, wherein said beam of neutrons comprises at least primarily neutrons having an energy greater than 6 MeV.

12. Detection system according to claim 1, wherein said neutron generator comprising a collimator for creating a fan beam of neutrons around an interrogation axis, wherein at a first distance from the neutron beam generator a first dimension of the fan beam in a first direction perpendicular to the interrogation axis is at least three times larger than a second dimension of the fan beam in a second direction perpendicular to the interrogation axis, the first direction being substantially perpendicular to the second direction.

13. The detection system according to claims 12, wherein a neutron detector is positioned opposite the neutron beam generator having dimensions substantially matching the dimensions of the fan beam at the position of the neutron detector.

14. The detection system according to claim 1, wherein the detection system is configured to move the item through the neutron beam for investigating the whole item.

15. Detection system according claim 14, wherein said inspection space comprises a displaceable support platform for receiving said item to be inspected, wherein said support platform is coupled to drive means that are configured to force said platform into a translation and/or a rotation during an investigation that is controlled by controller means.

16. Detection system according to claim 15, wherein said support platform is suspended for axial displacement along a traverse axis that is substantially perpendicular to said interrogation axis and/or wherein said support platform is suspended for a rotation around said traverse axis, wherein said drive means are configured to force said platform into an axial displacement along said traverse axis and/or said drive means that are configured to force said platform into a rotation around said traverse axis.

17. Detection system according to claim 1, wherein at least one further inspection space is provided along said interrogation axis of said directional beam of neutrons, in line with said first inspection space, said at least one further inspection space accommodating g a further item to be inspected concurrently with said first item to be inspected.

18. Detection system according to claim 17, wherein adjacent inspection spaces are shielded from one another by means of a neutron shield that has a window at said interrogation axis.

19. Detection system according to claim 18, wherein collimator means are provided along said window that are configured to collimate said at least one beam of energetic neutrons along said interrogation axis.

20. Detection system according to claim 1, wherein a pre-inspection space is provided receiving said item to be inspected prior to said inspection space, wherein said item is subjected to a flood inspection at said pre-inspection space.

21. Detection system according to claim 20, wherein said flood inspection comprises at least one of a visual inspection, an X-ray inspection and a beam of neutrons interrogation of said item.

22. Detection system according to claim 18, wherein said pre-inspection space is in line with said inspection space and said item is exposed at said pre-inspection space to said at least one beam of energetic neutrons at a diverged cross section that exposes a corresponding cross section of said pre-inspection space, particularly a corresponding cross section of said item to be inspected.

23. Detection system according to claim 20, characterized by transportation means, particularly comprising a conveyor belt, that carry said item to be inspected through said pre-inspection space and to either said inspection space or an output depending on an inspection outcome of said flood inspection of said item at said pre-inspection space.

24. A detection system according to claim 1, wherein said gamma ray detectors are accommodated in a housing in between collimator walls that collimate said gamma ray products created from the interaction of said item with said beam of neutrons, thereby focusing the subject detector on a particular voxel.

25. A detection system according to claim 24, wherein said gamma ray detectors and said collimator walls are axially displaceable with respect to one another to thereby shifting said detector in between said walls.

26. A detection system according to claim 1, wherein said interrogation axis by said beam of neutrons is inclined with respect to a face of said item under investigation.

27. A detection system according to claim 26, wherein said gamma ray detectors and said item under investigation are movable with respect to one another in a direction parallel to said item.

28. A detection system according to claim 27 wherein said gamma detectors move synchronously with the item under investigation.

29. A detection system according to claim 1, wherein said beam of neutrons emanate from said neutron beam generator through an aperture that is reduced to produce a substantially pencil shaped beam of neutrons.

30. A detection system according to claim 1, wherein said beam of neutrons emanate from said neutron beam generator through an aperture that is increased to produce a flood illumination by said beam of neutrons.

31. A method of non-invasive investigating a content of an item, wherein said item is exposed to a beam of neutrons that interact with material of said item to generate interaction products, wherein said interaction products are detected and analysed by means of processing means, wherein said item is exposed to an at least substantially uni-directional beam of energetic neutrons along an interrogation axis through said item, particularly a fan shaped beam, wherein said at least substantially uni-directional beam is provided with a cross section that is smaller, particularly at least said several times smaller, in at least one direction than a corresponding cross section of said item to be inspected to define a cross section of a voxel of a number of adjacent voxels within said item, wherein said interaction products are detected by means of at least one detector that is focused to a particular voxel to detect said interaction products along at least one detection axis upon interaction of said at least substantially uni-directional beam of energetic neutrons with local material within said voxel of said item to be inspected, and wherein said item is scanned in consecutive stages to cover said adjacent voxels in three cardinal directions along said item.

32. Method according to claim 31, wherein said beam of neutrons is pulsed and delivered as a series of consecutive bunches of energetic neutrons during a pulse time at a repetition rate.

33. Method according to claim 32, wherein said interaction products are detected and analysed during each bunch and/or in between bunches.

34. Method according to claim 31, wherein said item is rotated during inspection around an axis of rotation.

35. Method according to claim 34, wherein said item is translated parallel to, particularly along, said axis of rotation during said inspection.

36. Method according to claim 31, wherein one or more of: elastically scattered neutrons, inelastically scattered neutrons, transmitted neutrons, emitted neutrons and transmitted photons, particularly gamma ray photons, are being detected and analysed as interaction products.

37. Method according to claim 31, wherein several items are inspected concurrently using a common at least one, at least substantially uni-directional beam of energetic neutrons along said interrogation axis.

38. Method according to claim 31, wherein a neutron beam generator is used, comprising a Radio Frequency Quadrupole (RFQ) with an ion source and an target, wherein said ion source generates deuterium ions and said target holds deuterium within a metal.
